(19) United States
(12) Patent Application Publication
(10) Pub. No.: US 2013/0086201 A1
(43) Pub. Date: Apr. 4, 2013

(54) Mobile Patient Information System

(71) Applicant: Martyn Legge, Somersham (GB)

(72) Inventor: Martyn Legge, Somersham (GB)

(73) Assignee: Computer Sciences Corporation, Falls Church, VA (US)

(21) Appl. No.: 13/248,470

(22) Filed: Sep. 29, 2011

(51) Int. Cl. G06F 15/16

(52) U.S. Cl. 709/217

(57) ABSTRACT

In some embodiments, a mobile device comprises a network interface, a memory, and a processor. The network interface is operable to transmit communications between the mobile device and a patient data repository, the patient data repository storing information associated with a plurality of patients. The memory is operable to receive, from the patient data repository through the network interface, and store information associated with one or more patients. The processor is configured to receive a selection of a patient from a user; identify information associated with the selected patient stored in the memory; and provide, to an application local to the mobile device, the information associated with the selected patient from the memory.

### TECHNICAL FIELD

The present disclosure relates to mobile information systems and more specifically to a mobile patient information system.

### BACKGROUND

Mobile devices, such as mobile telephones (e.g., feature phones and smart phones), personal digital assistants (PDA), and mobile computers (e.g., tablet, netbook, and notebook computers), have become prevalent in people's daily lives. Many such devices are capable of supporting a variety of functionalities. Often, people carry relatively small and yet highly versatile mobile devices with them as they go through their daily lives (e.g., visit different places, participate in different events, perform different activities, etc.), and these mobile devices become extremely useful tools that bring convenience and flexibility to people's lives.

### SUMMARY

In some embodiments, a mobile device comprises a network interface, a memory, and a processor. The network interface is operable to transmit communications between the mobile device and a patient data repository, the patient data repository storing information associated with a plurality of patients. The memory is operable to receive, from the patient data repository through the network interface, and store information associated with one or more patients. The processor is configured to receive a selection of a patient from a user; identify information associated with the selected patient stored in the memory; and provide, to an application local to the mobile device, the information associated with the selected patient from the memory.

Certain embodiments may provide one or more technical advantages. A technical advantage of one embodiment may include the capability to allow a user to access patient information away from computer terminals, such as at a patient's residence or at an accident scene. A technical advantage of one embodiment may include the capability to provide a management application that manages patient information and user information between applications on a mobile device. A technical advantage of one embodiment may include the capability to retrieve user information for different applications and facilitate sharing of user information to authorize the user to access patient information using the different applications. Certain embodiments may overcome burdens associated with multiple, proprietary medical application vendors and speed patient information processing for the user.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its advantages, reference is now made to the following description taken in conjunction with the accompanying drawings, in which:

FIG. 1 shows a mobile patient information system according to one embodiment;

FIGS. 2A, 2B, and 2C show three examples of a provider interface having elements corresponding to the context manager and applications of FIG. 1 according to various embodiments; and

FIG. 3 shows an example method for providing patient information to an application on a mobile device using the system of FIG. 1 according to one embodiment.

### DETAILED DESCRIPTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

Mobile devices, such as mobile telephones (e.g., feature phones and smart phones), personal digital assistants (PDA), and mobile computers (e.g., tablet and netbook), are capable of performing a variety of functionalities, including but not limited to sending, receiving, and displaying data. Even with basic, low-end mobile devices, some form of data may be sent to or received from another device. For example, a basic feature phone still has the capability of making telephone calls, and thus exchanging voice data with another telephone, as well as sending short text messages. A more sophisticated mobile telephone (e.g., a smart phone) often has the capability of exchanging digital data (e.g., texts, images, audios, videos, etc.). In addition, almost all mobile devices include some amount of memory (e.g., internal or add-on memory cards), which may be used to store information or data. Again, a basic feature phone still has the capability of storing contact names and telephone numbers, and a more sophisticated mobile telephone has even more memory for storing various types of information.

Mobile devices may run a variety of applications that send, receive, and display data. For example, a mobile device may include an email application for sending, receiving, and displaying emails. As another example, a mobile device may include a calendar application for displaying calendar information as well as sending and receiving calendar invitations. As yet another example, a mobile device may include a map application for displaying maps and/or providing directions.

In some circumstances, a mobile device manufacturer may pre-load certain applications on a mobile device. For example, the email, calendar, and map applications mentioned above may be pre-loaded on a new mobile device. In addition to pre-loaded applications, a user may install third-party applications. For example, a user may install a map application that provides driving directions if the pre-loaded application does not offer driving directions.

Some applications may provide the ability to receive, display, edit, and send medical data, such as patient data. Medical data may present issues not associated with the example email, calendar, and map data discussed above. For example, different medical data may be stored on different proprietary servers maintained by different vendors, and each vendor may have its own proprietary application. If, for example, a user may want to retrieve a patient history, identify appointments with that patient, and find directions to the patient's residence, the vendor may have to use three different applications. Requiring additional data entries may be burdensome for the user, who may be required to input information identifying the patient into all three applications. In addition, due to privacy and/or security concerns, the applications may require the care provider to input security credentials three different times.

Accordingly, teachings of certain embodiments recognize the capability to provide a management application that manages patient information and user information between applications on a mobile device. For example, certain embodiments may retrieve patient information for different applications and facilitate sharing of patient information between applications. As another example, certain embodiments may retrieve user information for different applications and facilitate sharing of user information to authorize the user to access patient information using the different applications. Certain embodiments may overcome burdens associated with multiple, proprietary medical application vendors and speed patient information processing for the user.

In addition, certain embodiments may allow the user to have broader access to patient information. For example, certain embodiments may allow a user to access patient information away from computer terminals, such as at a patient's residence or at an accident scene. In addition, certain embodiments may allow a user to access information on a mobile device for a selected patient even if the mobile device does not have current access to data servers across a data network.

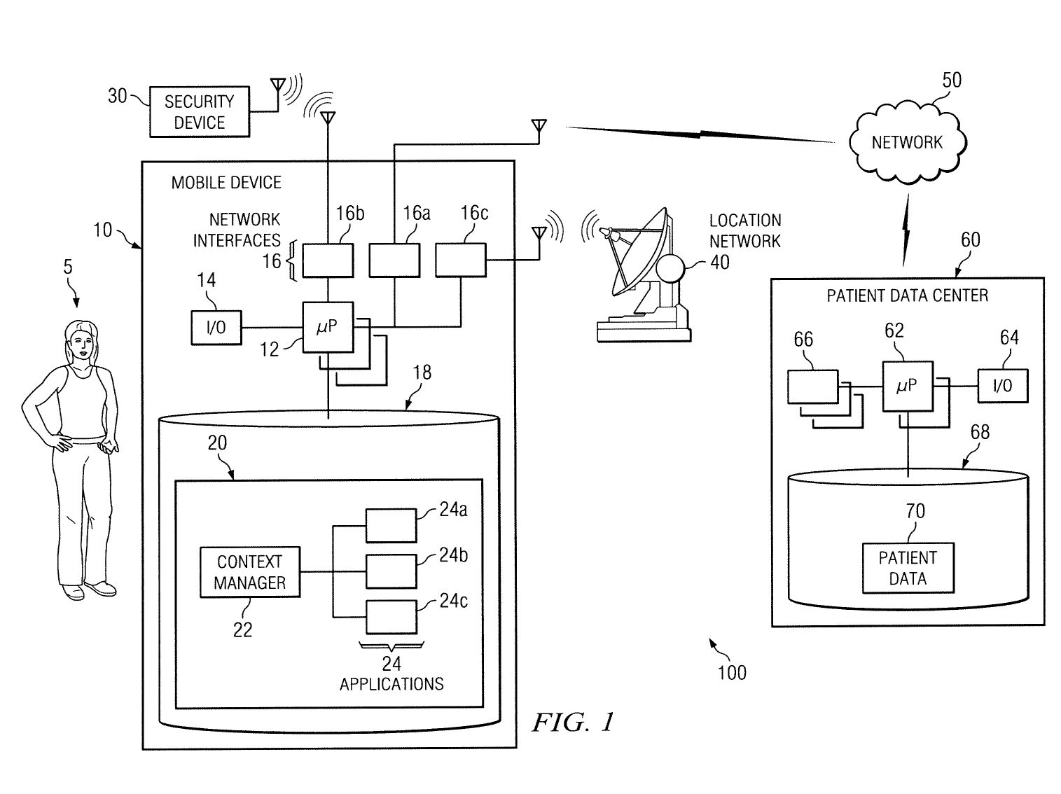

FIG. 1 shows a mobile patient information system 100 according to one embodiment. The mobile patient information system 100 of FIG. 1 features a mobile device 10, a security device 30, a location network 40, a data network 50, and a patient data center 60. In operation, a user 5 may interact with mobile device 10 to receive, display, edit, and/or send patient information from patient data center 60. Although the example of FIG. 1 shows one mobile device 10, one security device 30, one location network 40, one data network 50, and one patient data center 60, embodiments of system 100 may include more or fewer mobile devices 10, security devices 30, location networks 40, data networks 50, and/or patient data centers 60.

Users 5 may include any individual, group of individuals, and/or entity, that interacts with mobile device 10. Examples of users 5 include, but are not limited to, a doctor, nurse, care provider, medical technician, first responder, insurance specialist, analyst, manager, executive, accountant, engineer, technician, contractor, agent, and/or employee. Users 5 may be associated with an organization such as a hospital, mental health care provider, community health care provider, social or personal care provider, or other medical or social care organization.

Mobile device 10 may include processors 12, input/output devices 14, communications links 16, and memory 18. In other embodiments, mobile device 10 may include more, less, or other components. Mobile device 10 may be operable to perform one or more operations of various embodiments. Examples of a mobile device may include, but are not limited to, mobile telephones (e.g., feature phones and smart phones), personal digital assistants (PDA), and mobile computers (e.g., tablet and netbook).

Processors 12 represent one or more tangible hardware devices operable to execute logic contained within a medium. In particular embodiments, processor 12 includes hardware for executing instructions, such as those making up a computer program. As an example and not by way of limitation, to execute instructions, processor 12 may retrieve (or fetch) the instructions from an internal register, an internal cache, or memory 18; decode and execute them; and then write one or more results to an internal register, an internal cache, or memory 18. In particular embodiments, processor 12 may include one or more internal caches for data, instructions, or addresses. This disclosure contemplates processor 12 including any suitable number of any suitable internal caches, where appropriate. As an example and not by way of limitation, processor 12 may include one or more instruction caches, one or more data caches, and one or more translation lookaside buffers (TLBs). Instructions in the instruction caches may be copies of instructions in memory 18, and the instruction caches may speed up retrieval of those instructions by processor 12. Data in the data caches may be copies of data in memory 18 for instructions executing at processor 12 to operate on; the results of previous instructions executed at processor 12 for access by subsequent instructions executing at processor 12 or for writing to memory 18; or other suitable data. The data caches may speed up read or write operations by processor 12. The TLBs may speed up virtual-address translation for processor 12. In particular embodiments, processor 12 may include one or more internal registers for data, instructions, or addresses. This disclosure contemplates processor 12 including any suitable number of any suitable internal registers, where appropriate. Where appropriate, processor 12 may include one or more arithmetic logic units (ALUs); be a multi-core processor; or include one or more processors 12. Although this disclosure describes and illustrates a particular processor, this disclosure contemplates any suitable processor.

Input/output devices 14 may include any device or interface operable to enable communication between mobile device 10 and external components, including communication with a user or another system. Example input/output devices 14 may include, but are not limited to, a display, keyboard, touch screen, camera, and microphone. Input/output devices 14 may be external to or internal to mobile device 10. For example, input/output devices 14 may include both a built-in keyboard, a plug-in keyboard, and a wireless keyboard.

Network interfaces 16 are operable to facilitate communication between mobile device 10 and another element of a network. Network interfaces 16 may connect to any number and combination of wireline and/or wireless networks suitable for data transmission, including transmission of communications. Network interfaces 16 may, for example, communicate audio and/or video signals, messages, internet protocol packets, frame relay frames, asynchronous transfer mode cells, and/or other suitable data between network addresses. Network interfaces 16 connect to a computer network or a variety of other communicative platforms including, but not limited to, a wireless network, a cellular network, a public switched telephone network (PSTN); a public or private data network; one or more intranets; a local area network (LAN); a metropolitan area network (MAN); a wide area network (WAN); a local, regional, or global communication network; an optical network; a satellite network; a cellular network; an enterprise intranet; all or a portion of the Internet; other suitable network interfaces; or any combination of the preceding.

In the example of FIG. 1, mobile device 10 includes three network interfaces 16a, 16b, and 16c. Network interface 16a connects to network 50, allowing mobile device 10 to send and receive information with patient data center 60. Network interface 16b connects to security device 30. Security device 30 may provide authentication of user 5 to mobile device 10. In one example embodiment, network interface 16b and security device 30 are enabled for wireless communication, such as via Bluetooth or near-field communication. In another example embodiment, security device 30 may plug into mobile device 10 (e.g., smart security card). Network interface 16c connects to location network 40. In one example embodiment, network interface 16c is a global positioning system receiver that receives location signals from satellites within location network 40.

Memory 18 represents any suitable storage mechanism and may store any data for use by mobile device 10. Memory 18 may comprise one or more tangible, computer-readable, and/or computer-executable storage medium. Examples of memory 18 include computer memory (for example, Random Access Memory (RAM) or Read Only Memory (ROM)), mass storage media (for example, a hard disk), removable storage media (for example, a memory disk or smart card), database and/or network storage (for example, a server), and/or other computer-readable medium.

In some embodiments, memory 18 stores logic 20. Logic 20 facilitates operation of mobile device 10. Logic 20 may include hardware, software, and/or other logic. Logic 20 may be encoded in one or more tangible, non-transitory media and may perform operations when executed by a computer. Logic 20 may include a computer program, software, computer executable instructions, and/or instructions capable of being executed by mobile device 10. Example logic 20 may include any of the well-known mobile-device operating systems, such as Blackberry OS, Blackberry Tablet OS, Google Android, Windows Phone, webOS, Symbian OS, Apple iOS, and Samsung's Bada, as well as other operating systems such as OS2, UNIX, Mac-OS, Linux, and Windows Operating Systems or other operating systems. In particular embodiments, the operations of the embodiments may be performed by one or more computer readable media storing, embodied with, and/or encoded with a computer program and/or having a stored and/or an encoded computer program. Logic 20 may also be embedded within any other suitable medium without departing from the scope of the invention.

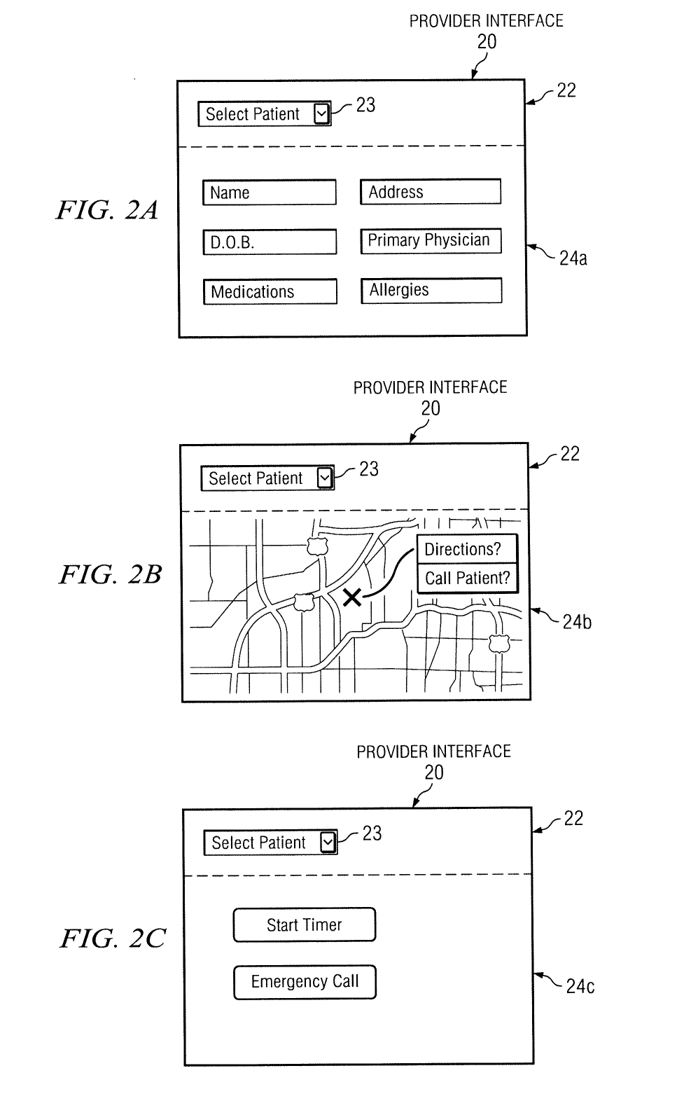

In the example of FIG. 1, logic 20 may include a context manager 22 and applications 24. Context manager 22 provides patient information to applications 24. In one example embodiment, context manager 22 receives patient information from patient data center 60 and shares the patient information with applications 24. Applications 24 provide functionality to user 5 using patient information received from context manager 22. For example, FIG. 1 shows three applications 24a, 24b, and 24c. In this example, application 24a displays patient information, such as a patient's name, address, date-of-birth, primary physician, medications, and allergies. Application 24b is a map application that displays the location and driving directions to a patient's residence. Application 24c provides functionality for a care provider who travels to patient homes. Application 24c may allow user 5 to, for example, record time spent at (and/or in route to/from) a patient's home or place an emergency call. Applications 24a, 24b, and 24c will be described in greater detail with regard to FIGS. 2A, 2B, and 2C.

Security device 30 may include any device operable to provide authorization information. For example, security device 30 may confirm the identity of user 5 to authorize user 5 to access patient information. In one example embodiment, security device 30 has a communication interface, such as a Bluetooth, radio-frequency identification (RFID), or near-field communication transmitter, that communicates with network interface 16b. For example, security device 30 may resemble a smart card with a built-in communication interface. In another example embodiment, security device 30 includes a card reader. User 5 may present an identification card (such as a smart card) to security device 30, which reads the card and transmits information identifying user 5 to mobile device 10. Mobile device 10 may use the received information to authorize user 5 to access patient information.

In some embodiments, security devices 30 may allow different users 5 to interact with the same mobile device 10. For example, different users 5 may have different security devices 30. Each security device 30 may identify user 5 to mobile device 10. If a user 5 presents a security device 30 to mobile device 10, mobile device 10 may provide access to patient data specific to the user 5. In one example, mobile device 10 may provide information for a specific set of patients (e.g., patients of user 5 or patients scheduled to see user 5 today) in response to receiving information from security device 30. In another example, mobile device 10 restricts patient information available to user 5 if security device 30 provides information indicating that user 5 has limited access.

Location network 40 may include any communication devices operable to provide location information to mobile device 10. One example of location network 40 may include satellites that provide global positioning information to mobile device 10. Another example of location network 40 may include a local positioning system with elements such as cellular base stations, Wi-Fi access points, trace networks (e.g., “fingerprinting), and radio broadcast towers. Network interface 16c may use any suitable method for determining the location of mobile device 10 using signals received from location network 40, such as triangulation and trilateration.

Network 50 may represent any number and combination of wireline and/or wireless networks suitable for data transmission. Network 50 may, for example, communicate internet protocol packets, frame relay frames, asynchronous transfer mode cells, and/or other suitable data between network addresses. In the example of FIG. 1, Network 50 is a cellular data network. In some embodiments, however, Network 50 may include any public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding. Although the illustrated embodiment shows one network 50, certain embodiments recognize that more or fewer networks may be used and that not all elements may communicate via a network. Certain embodiments also recognize that communications over a network is one example of a mechanism for communicating between parties, and any suitable mechanism may be used.

Patient data center 60 provides patient data to mobile device 10 across network 50. In the example of FIG. 1, patient data center 60 may represent a server or other computer system. Patient data center 60 may include processors 62, input/output devices 64, communications links 66, and memory 68. In other embodiments, patient data center 60 may include more, less, or other components. Patient data center 60 may be operable to perform one or more operations of various embodiments. Although the embodiment shown provides one example of patient data center 60 that may be used with other embodiments, such other embodiments may utilize computers other than patient data center 60. Additionally, embodiments may also employ multiple patient data centers 60 or other computers networked together in one or more public and/or private computer networks, such as one or more networks 30.

Processors 62 represent one or more tangible hardware devices operable to execute logic contained within a medium. In particular embodiments, processor 62 includes hardware for executing instructions, such as those making up a computer program. As an example and not by way of limitation, to execute instructions, processor 62 may retrieve (or fetch) the instructions from an internal register, an internal cache, or memory 68; decode and execute them; and then write one or more results to an internal register, an internal cache, or memory 68. In particular embodiments, processor 62 may include one or more internal caches for data, instructions, or addresses. This disclosure contemplates processor 62 including any suitable number of any suitable internal caches, where appropriate. As an example and not by way of limitation, processor 62 may include one or more instruction caches, one or more data caches, and one or more translation lookaside buffers (TLBs). Instructions in the instruction caches may be copies of instructions in memory 68, and the instruction caches may speed up retrieval of those instructions by processor 62. Data in the data caches may be copies of data in memory 68 for instructions executing at processor 62 to operate on; the results of previous instructions executed at processor 62 for access by subsequent instructions executing at processor 62 or for writing to memory 68; or other suitable data. The data caches may speed up read or write operations by processor 62. The TLBs may speed up virtual-address translation for processor 62. In particular embodiments, processor 62 may include one or more internal registers for data, instructions, or addresses. This disclosure contemplates processor 62 including any suitable number of any suitable internal registers, where appropriate. Where appropriate, processor 62 may include one or more arithmetic logic units (ALUs); be a multi-core processor; or include one or more processors 62. Although this disclosure describes and illustrates a particular processor, this disclosure contemplates any suitable processor.

Input/output devices 64 may include any device or interface operable to enable communication between patient data center 60 and external components, including communication with a user or another system. Example input/output devices 64 may include, but are not limited to, a mouse, keyboard, display, and printer.

Network interfaces 66 are operable to facilitate communication between patient data center 60 and another element of a network, such as other patient data centers 60. Network interfaces 66 may connect to any number and combination of wireline and/or wireless networks suitable for data transmission, including transmission of communications. Network interfaces 66 may, for example, communicate audio and/or video signals, messages, internet protocol packets, frame relay frames, asynchronous transfer mode cells, and/or other suitable data between network addresses. Network interfaces 66 connect to a computer network or a variety of other communicative platforms including, but not limited to, a public switched telephone network (PSTN); a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding.

Memory 68 represents any suitable storage mechanism and may store any data for use by patient data center 60. Memory 68 may comprise one or more tangible, computer-readable, and/or computer-executable storage medium. Examples of memory 68 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In some embodiments, memory 68 stores patient data 70. Patient data 70 may include any information associated with a patient, such as a patient name, social security number, address, date-of-birth, insurance, medications, allergies, patient history, diagnoses, health issues, clinical data, and family contact information. Patient data 70 may be used to identify a patient. For example, a patient may be identifiable by name, social security number, or other unique identifier.

In operation, according to one embodiment, context manager 22 may receive a list of patients. For example, context manager 22 may receive a list of patients scheduled to see user 5 on a particular day. In this example, the list of patients may be accompanied by an activity list, such as a list of scheduled appointments. In some embodiments, context manager 22 may receive the list of patients from patient data center 60 and/or one of applications 24. For example, application 24a may retrieve the list of patients from patient data center 60 and provide the list of patients to context manager 22.

In some embodiments, context manager 22 prompts user 5 to select a patient. For example, context manager 22 may provide a list of patients from which user 5 may select. Selecting a patient designates that patient as the “current patient.”

Context manager 22 may retrieve information for the current patient from patient data center 60 and/or one of applications 24. In some embodiments, context manager 22 may retrieve information for the current patient before user 5 selects the patient. For example, context manager 22 may retrieve the information with the list of patients received from patient data center 60 and/or one of applications 24. In other embodiments, context manager 22 may wait to retrieve information for the current patient until receive the selection from user 5. Examples of information for the current patient may include, but are not limited to, patient identification (e.g., a patient number or code), patient name, patient address, patient postal code, patient date-of-birth, patient calendar details, and patient event descriptions.

Context manager 22 may make information for the current patient available to applications 24. For example, context manager 22 may manage a local store of patient information on mobile unit 5 and retrieve information from the local store in response to requests from applications 24. In some embodiments, the local store may be encrypted to restrict access by applications 24 and other applications. When user 5 and/or context manager 22 requests that an application 24 perform some task regarding a patient, the application 24 may use the information for the current patient provided by context manager 22 from the local store. If user 5 requests that a different application 24 perform a different task, the different application 24 may also use the information for the same current patient provided by context manager 22 to the previous application 24.

Thus, certain embodiments recognize that user 5 can navigate between applications 24 without reentering patient information. If, for example, user 5 wants to (1) review patient records using a first application 24 and then (2) view a map of the patient's residence using a second application 24, context manager 22 allows user 5 to view the map without providing new patient information to second application 24. In addition, context manager 22 may allow different applications 24 to share information. In the previous example, the address displayed in the patient records using the first application 24 should correspond to the address mapped using the second application 24 because both applications and providing information on the same patient. As another example, user 5 may use a third application 24 to capture camera images to be saved in the patient records viewed using the first application 24. As yet another example, user 5 may use a fourth application 24 to track time spent at different locations. In this example, fourth application 24 can match time records with patient records provided by the first application 24.

As stated above, context manager 22 may provide information for a selected patient to applications 24. In one example embodiment, an application 24 provides the capability to be used by context manager 22. For example, a navigation application 24 may be started from context manager 22. If user 5 has selected a patient, then context manager 22 provides address details for the patient to application 24 from the local store. From the perspective of the navigation application 24, if the navigation application 24 receives an address from context manager 22, then navigation application 24 obtains the current GPS location of mobile unit 10, generates a route from the current GPS location of mobile unit 10 and the address of the selected patient, and provides navigation information to user 5. If navigation application 24 does not receive an address from context manager 22, navigation application 24 prompts user 5 to provide a destination address (which may not be associated with a patient), generates a route from the current GPS location of mobile unit 10 and the address of the selected patient, and provides navigation information to user 5.

In the previous example describing communications between context manager 22 and a navigation application 24, context manager 22 transmits communications to navigation application 24, but navigation application 24 does not necessarily transmit communications to context manager 22. In this example, context manager 22 may include an interface for communicating with an application 24, but the application may not necessarily include an interface for communicating back with context manager 22.

Some embodiments, however, may provide for bi-directional communications between context manager 22 and applications 24. For example, some applications 24 may not be able to proceed without patient information. For example, unlike a navigation application 24, a patient record application 24 may not be able to provide any utility without patient information. In this example, the patient record application 24 may include an interface for communicating with context manager 22. This interface may allow patient record application 24 to, for example, query whether context manager 22 has patient context information (e.g., has user 5 selected a patient), request patient context information from context manager 22, and/or prompt user 5 to select a patient. In another example, the interface may allow patient record application 24 to add or delete patient details in the local store.

In some embodiments, context manager 22 may include an interface unique to a particular application 24. For example, a worker protection application 24 may allow user 5 to keep track of patient visits and request help if problems arise while visiting a patient. In this example, context manager 22 may include an interface that allows context manager 22 to start and stop a visit.

Certain embodiments also recognize that context manager 22 may aggregate information regarding multiple patients for user 5. For example, as stated above, a calendar application may present a daily schedule of patient visits. To do so, context manager 22 may retrieve names and scheduled appointment times for several patients. The names may be placed in a calendar according to their corresponding scheduled appointment times.

In some embodiments, context manager 22 may retrieve patient data 70 for a particular patient on an as-needed basis. In other embodiments, context manager 22 may retrieve a set of patient data 70 for a particular patient. For example, if user 5 does not have constant access to network 50 (e.g., out of service area), context manager 22 may retrieve a set of patient data 70 (e.g., all patient data, a category of patient data) for a particular patient for later off-line use. In some circumstances, the set of patient data 70 may be stored in volatile data memory on mobile device 10 such that the set of patient data 70 will be deleted from mobile device 10 if mobile device 10 is lost, stolen, reset, or turned-off or if the current patient is unselected or replaced. In some embodiments, context manager 22 may retrieve a set of patient data 70 for multiple patients if, for example, user 5 has scheduled appointments with multiple patients that day.

In addition to saving user 5 time by providing patient information to multiple applications 24, context manager 22 may also provide authorization information to multiple applications 24. For example, patient data center 60 may require that user 5 be authorized to access patient data 70. In this example, any application 24 attempting to retrieve patient data 70 may be required to present evidence of authorization. Context manager 22 may provide such evidence of authorization to any application 24 attempting to retrieve patient data 70. If user 5 is required to enter a password for authorization, for example, context manager 22 may receive the password once and then provide authorization for each application 24 without requiring user 5 to enter or re-enter the password. If user 5 is required to provide user information, for example, context manager 22 may receive and store the user information once and then provide the user information for each application 24 without requiring user 5 to enter or re-enter user information. Example user information may include, but is not limited to, user identification (e.g., identification number), user name, user address, user postal code, user phone numbers (e.g., a phone number associated with the mobile unit), user email address (e.g., an email address associated with the mobile unit), and user vehicle registration number.

Applications 24 may allow user 5 to edit or add to patient data. For example, user 5 may add notes, add pictures, change prescriptions, change personal information, or update a status of a patient. In some embodiments, context manager 22 may receive new or edited patient information from applications 24 and promulgate corresponding changes to patient data 70 in patient data center 60. In some embodiments, context manager 22 may queue the corresponding changes for later reconciliation with patient data 70 in patient data center 60. For example, if mobile device 10 does not have access to network 50, context manager 22 may hold on to changes to patient data until access to network 50 has been restored.

In some embodiments, context manager 22 may communicate with patient data center 60 across network 50. In other embodiments, context manager 22 may delegate certain tasks to one of applications 24. For example, an application 24 may be responsible for retrieving a list of patients and information regarding those patients. Application 24 may provide the retrieved list and information for context manager 22, which may present the list of patients to user 5. In some embodiments, context manager 22 may use applications 24 such as Inchware, Rio, and Patient Keeper to retrieve patient information from patient data center 60.

In some embodiments, context manager 22 may specify the format patient data will be provided to applications 24. For example, context manager 22 may provide patient data in the same format to every application 24, and each application 24 may be configured to read the patient data in the format specified by context manager 22. In some embodiments, context manager 22 may reformat patient data for particular applications 24, minimizing changes to applications 24 by allowing applications 24 to read data in a native format.

Context manager 22 and applications 24 may also allow user 5 to collect patient information for various reports. For example, a first application 24 may display patient records, a second application 24 may locate patients on a map, and a third application 24 may keep track of the time user 5 spends with each patient. Individually, each application 24 includes some information about the patients of user 5 and the time spent by user 5 with each patient. In certain embodiments, context manager 22 may aggregate information from each application 24 to provide a more comprehensive report about the patients of user 5 and the time spent by user 5 with each patient. For example, context manager 22 may generate a mileage report for user 5 by comparing the timer information from the third application 24 with the mapping information from the second application 24 and the patient information from the first application 24.

In some embodiments, portions of patient data 70 may be stored in any of three places: mobile device 10, patient data center 60, and cached somewhere within network 50. In one example, patient data center 60 may execute electronic patient record (EPR) retrieval software such as TPP SystmOne client, and mobile device 10 may execute EPR mobile software such as Inchware Mobile Client. In this example, the EPR retrieval software may transmit patient records to the EPR mobile software across an encrypted network, such as by using BlackBerry Enterprise Server. For example, patient records may be encrypted by using AES-256 encryption over secure HTTP. Messages that cannot be transmitted if, for example, mobile device 10 does not have access to network 50, may be cached in an SQL sever database for a configurable period of time. The messages may remain encrypted with AES-256 while in the SQL server database.

In this example, context manager 22 may use EPR mobile software such as Inchware Mobile Client to provide a list of patients to context manager 22 to allow user 5 to select patient context. For example, context manager 22 may receive selection of a patient from user 5 and then request the EPR mobile software to retrieve information about the selected patient from the EPR retrieval software. Context manager 22 may then make the retrieved information available to applications 24. For example, one application 24 may be an Inchware client for viewing patient records. Allowing the Inchware client to request patient information from context manager 22 may eliminate the need for user 5 to reenter patient information into the Inchware client.

In some embodiments, applications 24 may request patient information from context manager 22 rather than requesting patient information directly from patient data center 60. In this example, applications 24 may be modified to send a request to context manager 22 in a format suitable to context manager 22 rather than send a request for patient information to patient data center 60. In one example, applications 24 may send two requests: a first request asking whether user 5 has selected a patient and a second request asking for information associated with the selected patient. If no current patient has been selected, context manager 22 and/or applications 24 may prompt user 5 to select a patient. Some applications 24, however, may continue operation without prompting user 5 to select a patient. For example, a satellite navigation application 24 may prompt user 5 to input an address rather than to select a patient. As another example, a patient record application 24 such as Inchware client may request information from patient data center 60 if no current patient is selected. In some embodiments, application 24 may be instructed to request patient information from patient data center 60 if context manager 22 does not include that patient information. For example, context manager 22 may only maintain basic patient identifiers (e.g., name, date-of-birth, and address) and may not include patient record details.

In some embodiments, context manager 22 may integrate with an address book of the mobile device 10. For example, contacts of user 5 such as colleagues and patients may be placed in a special address list category. Context manager 22 may retrieve and display only those colleagues and patients placed in the special address list category, allowing user 5 to search through contacts without having to scroll through non-work contacts.

FIGS. 2A, 2B, and 2C show three examples of a provider interface according to various embodiments. FIG. 2A shows a provider interface 200a with elements corresponding to context manager 22 and application 24a. In this example, application 24a displays patient information, such as a patient's name, address, date-of-both, primary physician, medications, and allergies, for the patient selected in context manager 22. Certain embodiments recognize that application 24a may show more, fewer, or different types of patient information.

FIG. 2B shows a provider interface 200b with elements corresponding to context manager 22 and application 24b. Application 24b is a map application that displays the location and/or driving directions for the patient selected in context manager 22. FIG. 2B also provides user 5 with the option to call the patient using a telephone system associated with mobile device 10. Thus, for example, user 5 may call the patient while in-route without opening up a different application 24 to look up the patient's phone number. Instead, context manager 22 would share the patient's phone number with application 24b without requiring user 5 to switch out of application 24b. In some embodiments, user 5 may also call the patient using context manager 22 and/or a phone application of the mobile device 10.

FIG. 2C shows a provider interface 200c with elements corresponding to context manager 22 and application 24c. Application 24c provides functionality for a care provider who travels to patient homes. Application 24c may allow user 5 to, for example, record time spent at a patient's home or place an emergency call. In the example of FIG. 2C, user 5 may start a timer for the patient selected in context manager 22. In addition, user 5 may place an emergency call to dispatch emergency personnel to the residence of the patient selected in context manager 22.

In some embodiments, application 24c monitors the activity of the user 5 for safety purposes. For example, application 24c may require user 5 to check in periodically when at a patient's residence. If user 5 does not check in, application 24c may determine that the safety of user 5 is in question and take one or more corrective actions. For example, application 24c may instruct an entity (e.g., company responsible for safety of user 5) to call user 5. As another example, application 24c may try to monitor the situation, such as enabling audio and/or a camera of mobile device 10, and transmit information back to an entity for review. As yet another example, application 24c may call a Public Safety Answering Point (PSAP) or other emergency response entity. In this example, application 24c may provide the location of mobile device 10 (e.g., GPS location) to the PSAP or other emergency response entity.

Application 24c may use a variety of information received from context manager 22. For example, context manager 22 may provide patient identification, patient name, patient address, patient postal code, patient age, patient date-of-birth, and patient blood group as well as user information, user identification, user name, user home postal code, user vehicle registration number, and user mobile unit number to application 24c at the beginning of a patient visit. When the patient visit ends, context manager 22 may provide patient identification, user identification, date, and time information to application 24c.

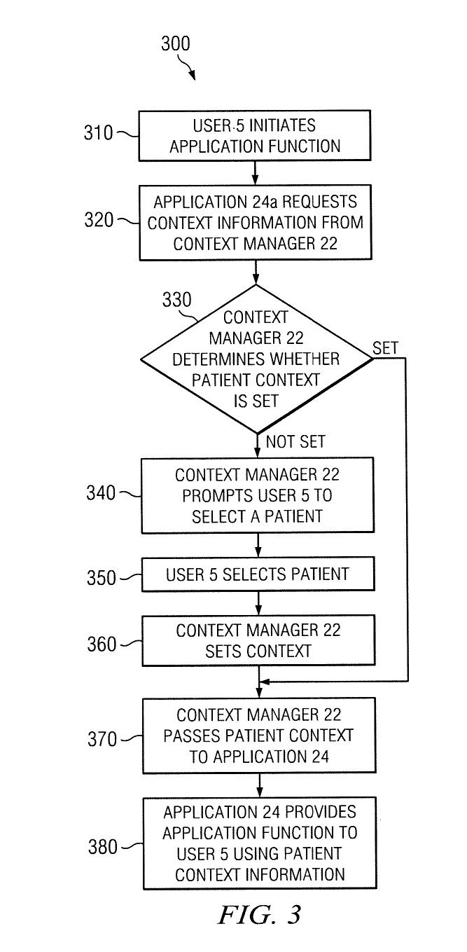

FIG. 3 shows a method 300 for providing patient information to an application on a mobile device according to one embodiment. At step 310, user 5 initiates an application function in an application, such as application 24a. For example, user 5 may request display of or edits to patient information. At step 320, application 24a requests context information from context manager 22. The context information may identify, among other things, a current patient selected by user 5.

At step 330, context manager 22 determines whether patient context has been set. If patient context has not been set, context manager 22 prompts user 5 to select a patient at step 340. User 5 selects a patient at step 350, and context manager 22 sets the patient context based on the selection at step 360. At step 370, context manager 22 passes patient context to application 24. At step 380, application 24 provides the application function to user 5 using the patient context information.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patient issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A mobile device, comprising:
a network interface operable to transmit communications between the mobile device and a patient data repository, the patient data repository storing information associated with a plurality of patients;
a memory operable to receive, from the patient data repository through the network interface, and store information associated with one or more patients; and
a processor, communicatively coupled to the memory, the processor configured to:
receive a selection of a patient from a user;
identify information associated with the selected patient stored in the memory; and
provide, to an application local to the mobile device, the information associated with the selected patient from the memory.

2. The mobile device of claim 1, wherein the processor is configured to receive a selection of the selected patient from a user by:
identifying each of the one or more patients to the user; and
receiving a selection of one of the one or more patients from the user.

3. The mobile device of claim 1, wherein the processor is configured to provide instructions to the application to perform a task using the information associated with the selected patient.

4. The mobile device of claim 1, wherein the processor is configured to provide, to the application, the information associated with the selected patient in response to a request, from the application, for current patient information.

5. The mobile device of claim 4, the processor being further configured to:
receive a second selection of a second patient;
retrieve, using the network interface, information associated with the second selected patient from the patient data repository;
store the information associated with the second selected patient in place of the information associated with the selected patient; and
provide, in response to a second request from the application, the information associated with the second selected patient from the memory.

6. The mobile device of claim 1, wherein the network interface is operable to communicate with a patient data repository across a cellular data network.

7. The mobile device of claim 1, wherein:
the mobile device further comprises a global positioning system operable to provide a location of the mobile unit;
the application is operable to provide directions between the location of the mobile unit and a second location;
the information associated with the selected patient comprises an address of the selected patient; and
the processor is further configured to:
receive, from the application, a request for the second location; and
provide, to the application, the address of the selected patient as the second location.

8. The mobile device of claim 1, wherein the application is operable to retrieve, using the network interface, additional information associated with the selected patient from the patient data repository.

9. The mobile device of claim 1, the processor further configured to:
determine whether the user has selected a patient; and
if the user has not selected a patient, prompt, in response to a request for current patient information, the user to select a patient.

10. A non-transitory computer readable medium comprising logic for execution, the logic, when executed by a processor, operable to:
receive, from a remote data repository, and store information associated with one or more patients;
receive a selection of a patient from a user;
identify information associated with the selected patient from the data associated with the one or more patients; and
provide, to an application local to the medium, the information associated with the selected patient from the memory.

11. The medium of claim 8, the logic, when executed, being further operable to receive a selection of the selected patient from a user by:
identifying each of the one or more patients to the user; and
receiving a selection of one of the one or more patients from the user.

12. The medium of claim 8, the logic, when executed, being further operable to provide instructions to the application to perform a task using the information associated with the selected patient.

13. The medium of claim 8, the logic, when executed, being further operable to provide, to the application, the information associated with the selected patient in response to a request, from the application, for current patient information.

14. The medium of claim 13, the logic, when executed, being further operable to:
receive a second selection of a second patient;
retrieve, using the network interface, information associated with the second selected patient from the patient data repository;
store the information associated with the second selected patient in place of the information associated with the selected patient; and
provide, in response to a second request from the application, the information associated with the second selected patient from the memory.

15. The medium of claim 8, the logic, when executed, being further configured to retrieve the information associated with the selected patient across a cellular data network.

16. The medium of claim 8, wherein:
the application is operable to:
request a location of the computer-readable medium from a global positioning system; and
provide directions between the requested location and a second location;
the information associated with the selected patient comprises an address of the selected patient; and
the logic when executed is further operable to:
receive, from the application, a request for the second location; and
provide, to the application, the address of the selected patient as the second location.

17. The medium of claim 8, wherein the application is operable to retrieve additional information associated with the selected patient from the patient data repository.

18. The medium of claim 8, the logic, when executed, being further operable to:
determine whether the user has selected a patient; and
if the user has not selected a patient, prompt, in response to a request for current patient information, the user to select a patient.

19. A method for providing patient data to applications on a mobile device, comprising:
receiving, from a patient data repository remote from the mobile device, and storing information associated with one or more patients;
receiving a selection of a patient from a user;
identifying information associated with the selected patient from the data associated with the one or more patients; and
providing, to an application local to the mobile device, the information associated with the selected patient from the memory.

20. The method of claim 15, wherein receiving a selection of the selected patient from a user comprises:
identifying each of the one or more patients to the user; and
receiving a selection of one of the one or more patients from the user.

21. The method of claim 15, wherein providing the information to the application further comprises providing instructions to the application to perform a task using the information associated with the selected patient.

22. The method of claim 15, wherein providing the information to the application comprises providing, to the application, the information associated with the selected patient in response to a request, from the application, for current patient information.

23. The method of claim 15, further comprising:
receiving a second selection of a second patient;
retrieving, using the network interface, information associated with the second selected patient from the patient data repository;
storing the information associated with the second selected patient in place of the information associated with the selected patient; and
providing, in response to a second request from the application, the information associated with the second selected patient from the memory.

24. The method of claim 15, wherein:
the application is operable to:
request a location of the mobile unit from a global positioning system; and
provide directions between the requested location and a second location;
the information associated with the selected patient comprises an address of the selected patient, and
the method further comprises:
receiving, from the application, a request for the second location; and
providing, to the application, the address of the selected patient as the second location.

25. The method of claim 15, further comprising:
determining whether the user has selected a patient; and
if the user has not selected a patient, prompting, in response to a request for current patient information, the user to select a patient.
